(19) United States
(12) Patent Application Publication
(10) Pub. No.: US 2019/0305578 A1
(43) Pub. Date: Oct. 3, 2019

(54) Wireless Charger Device for Mobile Devices

(71) Applicant: Paradox Ventures LLC, Sheridan, WY (US)

(72) Inventor: Anthony M. Cerasani, Gilbert, AZ (US)

(21) Appl. No.: 16/367,051

(22) Filed: Mar. 27, 2019

Related U.S. Application Data
(60) Provisional application No. 62/648,844, filed on Mar. 27, 2018.

(51) Int. Cl. H02J 7/02; H02J 7/00; H02J 50/12

(52) U.S. Cl. CPC H02J 7/025; H02J 7/007; H02J 50/12; H02J 7/0045

(57) ABSTRACT

Implementations of charging devices may include: a casing having a first side and a second side and a charging pad on a first side of the casing. Charging devices may include one or more inductive coils adjacent to the first side of the casing and adjacent to the charging pad. A battery pack may be included within the casing of the charging devices. Charging devices may also include an electrical power plug rotatably coupled to a second side of the casing. The electrical power plug may be configured to be inserted into an electrical outlet. Charging devices may also include a controller. The controller may be configured to control the resonant coupling between the one or more inductive coils and an inductive coil in a device being charged.

### CROSS REFERENCE TO RELATED APPLICATIONS

This document claims the benefit of the filing date of U.S. Provisional Patent Application 62/648,844, entitled “Wireless Charger” to Anthony M. Cerasani which was filed on Mar. 27, 2018, the disclosure of which is hereby incorporated entirely herein by reference.

### BACKGROUND

### 1. Technical Field

Aspects of this document relate generally to wireless devices, such as chargers for personal electronic devices. More specific implementations involve chargers for cell phone, tablets, laptops, and other electronic devices.

### 2. Background

Conventionally, to charge a personal electronic device using a wireless charger, the personal electronic device is laid flat on a surface of a wireless charging device. A wireless charging device typically charges a personal electronic device without a cord connecting the charging device to the personal electronic device. The charging device itself must be connected to a power source using a cord while the personal electronic device charges.

### SUMMARY

Implementations of charging devices may include: a casing having a first side and a second side and a charging pad on a first side of the casing. Charging devices may include one or more inductive coils adjacent to the first side of the casing and adjacent to the charging pad. A battery pack may be included within the casing of the charging devices. Charging devices may also include an electrical power plug rotatably coupled to a second side of the casing. The electrical power plug may be configured to be inserted into an electrical outlet. Charging devices may also include a controller. The controller may be configured to control the resonant coupling between the one or more inductive coils and an inductive coil in a device being charged. The electrical power plug may be configured to charge the battery pack and the battery pack may be configured to energize the one or more inductive coils. The one or more inductive coils may be configured to wirelessly transmit energy to an electronic device disposed on or adjacent to the charging pad.

Implementations of charging devices may include one, all, of any of the following:

Charging devices may include a second controller that is coupled to a display and a memory of the device.

The electrical power plug may be hingedly coupled to the second side of the casing.

Charging devices may include a stand rotatably coupled to a second side of the casing adjacent to the electrical power plug and a pull out rotatably coupled to an inner portion of the stand. The pull out portion may be configured to maintain an angle of the wireless charger when the electrical power plug of the device is inserted into an electric outlet.

Charging devices may further include a first set of magnets and a second set of magnets. The first set of magnets and the second set of magnets may be positioned on opposite sides of the one or more inductive coils. The first set of magnets and the second set of magnets may be configured to engage a personal electronic device to couple the personal electronic device with the charging pad.

Charging devices may also include a shelf coupled to a first end of the casing. The shelf may be configured to support an electronic device.

Charging devices may also include a display on a second end of the casing.

A magnetic mount may be on a second side of the casing. The magnetic mount may be configured to couple with a metal surface having one of a circular shape or a planar shape.

Charging devices may further include at least one of a universal serial bus (USB) type A port, a USB type C port, a non-volatile data storage, or any combination thereof.

The controller of the device may be configured to follow a hierarchy of charging when plugged into a wall wherein any other electronic device coupled with the device is charged before the battery pack.

Implementations of charging devices may include: a casing having a battery pack and one or more inductive coils embedded within a cavity of the casing. Charging devices may also include a charging pad on a first outer surface of the casing and an electrical power plug rotatably coupled to a second side of the casing. The electrical power plug may be configured to be inserted into an electrical outlet. Charging devices may also include a display comprised on a first outer surface of the casing adjacent the charging pad and a button on an edge of the casing. The button may be configured to toggle between one or more modes on the display. A shelf may also be on a first end of the casing. The shelf may configured to support an electronic device. The electrical power plug may be configured to charge the battery pack and the battery pack may be configured to charge the one or more inductive coils. The one or more inductive coils may be configured to wirelessly transmit energy to an electronic device disposed on or adjacent to the charging pad.

Implementations of charging devices may include one, all, or any of the following:

Charging devices may further include a controller that is configured to control the resonant coupling between the one or more inductive coils and an inductive coil in a device being charged.

Charging devices may further include a stand rotatably coupled to a second side of the casing adjacent to the electrical power plug and a pull out rotatably coupled with the stand. The pull out may be configured to maintain an angle of the charging device when the electrical power plug of the device is inserted into an electrical outlet.

Charging devices may further include a magnetic mount on a second side of the casing. The magnetic mount may be configured to couple with a metal surface having a circular shape.

Charging devices may also include at least one of a universal serial bus (USB) type A port, a USB type C port, a non-volatile data storage, wireless storage data, or any combination thereof.

Charging devices may also include at least one set of magnets. The at least one set of magnets may be configured to engage a personal electronic device to couple the personal electronic device with the charging pad.

Implementations of charging devices may include: a casing having a first side and a second side and a charging pad on a first side of the casing. Charging devices may also include one or more inductive coils adjacent to the first side of the casing and adjacent to the charging pad. A battery pack may be included within the casing of the charging devices. Charging devices may also include an electrical power plug rotatably coupled to a second side of the casing. The electrical power plug may be configured to be inserted into an electrical outlet. Charging devices may also include a controller. The controller may be configured to control the resonant coupling between the one or more inductive coils and an inductive coil in a device being charged. Charging devices may also include a second charging pad comprised on a first side of the casing. The electrical power plug may be configured to charge the battery pack and the battery pack may be configured to energize the one or more inductive coils. The one or more inductive coils may be configured to wirelessly transmit energy to an electronic device disposed on or adjacent to the charging pad.

Implementations of charging devices may include one, all, of any of the following:

Charging devices may also include a stand rotatably coupled to a second side of the casing adjacent to the electrical power plug and a pull out rotatably coupled to an inner portion of the stand. The pull out portion may be configured to maintain an angle of the device when the electrical power plug of the device is inserted into an electric outlet.

Charging devices may further include a shelf comprised on a first end of the casing. The shelf may be configured to support an electronic device.

The controller of the device may be configured to follow a hierarchy of charging when plugged into a wall wherein any other electronic device coupled with the charging device is charged before the battery pack.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is a front view of a first side of an implementation of a charging device;

FIG. 2 is a bottom perspective view of an implementation of a charging device;

FIG. 3 is a top perspective view of an implementation of a charging device;

FIG. 4 is a front view of a second side of an implementation of a charging device;

FIG. 5 is a side view of an implementation of a charging device;

FIG. 6 is a top view of a second end of an implementation of a charging device;

FIG. 7 is a top view of a first end of an implementation of a charging device;

FIG. 8 is a side view of an implementation of a charging device with an implementation of a stand and an electrical power plug in an open position;

FIG. 9 is a top perspective view of an implementation of a charging device with an implementation of a stand and an electrical power plug in an open position;

FIG. 10 is a front view of a first side of another implementation of a charging device;

FIG. 11 is a bottom perspective view of another implementation of a charging device;

FIG. 12 is a top perspective view of another implementation of a charging device;

FIG. 13 is a side view of another implementation of a charging device;

FIG. 14 is a front view of a second side of another implementation of a charging device;

FIG. 15 is a top view of a second end of another implementation of a charging device;

FIG. 16 is a top view of a first end of another implementation of a charging device;

FIG. 17 is a side view of another implementation of a charging device with an implementation of a stand and an electrical power plug in an open position;

FIG. 18 is a top perspective view of another implementation of a charging device with an implementation of a stand and an electrical power plug in an open position;

FIG. 19 is a perspective view of an additional implementation of a charging device;

FIG. 20 is a front view of a first side of an additional implementation of a charging device;

FIG. 21 is front view of a second side of an additional implementation of a charging device;

FIG. 22 is a side view of an additional implementation of a charging device with an electrical power plug is an open position;

FIG. 23 is a perspective view of an alternative implementation of a charging device;

FIG. 24 is a front view of a first side of an alternative implementation of a charging device;

FIG. 25 is a front view of a second side of an alternative implementation of a charging device; and

FIG. 26 is a side view of an additional implementation of a charging device with an electrical power plug is an open position.

### DESCRIPTION

This disclosure, its aspects and implementations, are not limited to the specific components, assembly procedures or method elements disclosed herein. Many additional components, assembly procedures and/or method elements known in the art consistent with the intended charging devices will become apparent for use with particular implementations from this disclosure. Accordingly, for example, although particular implementations are disclosed, such implementations and implementing components may comprise any shape, size, style, type, model, version, measurement, concentration, material, quantity, method element, step, and/or the like as is known in the art for such charging devices, and implementing components and methods, consistent with the intended operation and methods.

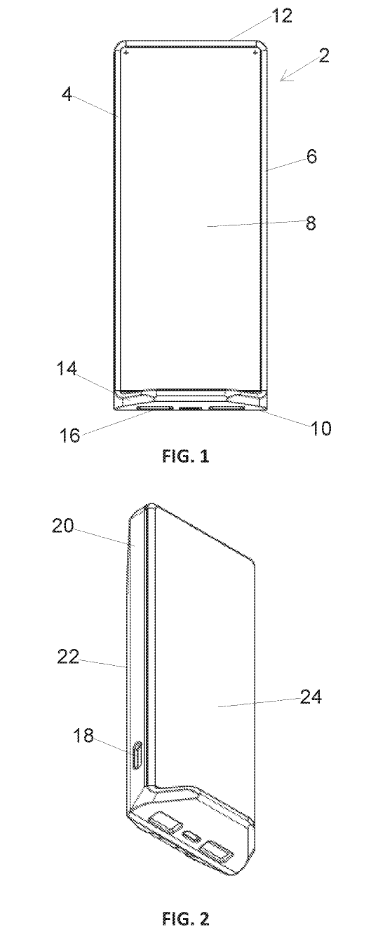

Referring to FIG. 1, an implementation of a charging device 2 is illustrated. The charging device includes a casing 4. The first side 6 of the casing 4 includes a charging pad 8. As illustrated, the charging pad 8 extends from a first end 10 of the casing 4 to a second 12 end of the casing 4. In various implementations, the charging pad 8 may be shorter and may not extend across the entire length of the first side 6 of the casing 4. The casing includes a cavity between the first side and the second side of the casing. A battery pack is included within the casing. In various implementations, the battery pack may be embedded in a material of the casing. The casing may be formed through injection molding in various implementations and the molding may encase any components within the casing of the charging device. Components within the casing may include a battery, one or more inductive coils, a controller, and other electrical components required to operate charging devices as described herein. In other implementations, the casing may be formed through three dimensional 3D printing. In some implementations, the casing may be hollow and the required electrical components may be included within the cavity of the casing.

The one or more inductive coils included in the casing may be positioned adjacent to the first side of the casing and adjacent to the charging pad. The one or more inductive coils may be configured to wirelessly transmit energy to an electronic device disposed on or adjacent to the charging pad. The controller included within the casing may be configured to control the resonant coupling between the one or more inductive coils and an inductive coil in a device being charged. In various implementations, the charging pad may utilize the Qi wireless charging standard developed by the Wireless Power Consortium of Piscataway, N.J. In various implementations, the controller of the device may be configured to follow a hierarchy of charging when the charging device plugged into a wall, which will be described in more detail throughout this document. The hierarchy may specify that any other electronic device coupled with the charging device is charged before the battery pack. Once the battery pack is charged, other devices may be powered through an electrical power plug of the charging device inserted into an electrical outlet.

Still referring to FIG. 1, an implementation of a charging device may include a shelf 14. The shelf 14 may be coupled with the first end 10 of the casing 4. The shelf may be configured to support an electronic device. In various implementations, the shelf may support the electronic device when the charging device is sitting on a desk or other flat surface. In some implementations, the charging device may act as a docking stand. The electronic device may be a personal electronic device such as, by non-limiting example, a cellular phone or a tablet. In some implementations, the shelf may be rotatably coupled to the first end of the casing and may be folded into a closed position to create a substantially flat first surface of the casing for more convenient storage. In other implementations, the shelf may be stationary and the entire casing may be formed a single piece of material. In some implementations, the shelf may have a substantially rectangular shape. In still other implementations, by non-limiting example, the shelf may have a rounded shape, a triangular, a trapezoidal shape, or any other geometric shape that provides support for a personal electronic device. In FIG. 5, a side view of an implementation of a charging device illustrates the shelf in a fully extended position.

In various implementations, the charging device 2 may include one or more ports 16 on an edge of the first side of the casing. In some implementations, as will be illustrated in other figures, the ports may be positioned on the edges of the casing. The ports may include universal serial bus (USB) ports including micro-USB ports. The USB ports may include type A ports, type C ports, or any combination thereof. The ports may be used to access non-volatile data storage or wireless storage data include within the casing of the device. In various implementations, the ports may be used to charge additional electronic devices as controlled by the controller of the charging device. The additional electronic devices may be charged through standard charging cords coupled to the ports. In some implementations, the ports may be used to charge the battery pack of the charging device. Referring to FIG. 7, a top view of the one or more ports on the first side of the charging device is illustrated.

Referring to FIG. 2, a side perspective view of an implementation of a charging device is illustrated. In this view, an implementation of an additional port 18 is illustrated on an edge of the casing. The edge 20 of the casing is between the first side 24 of the casing and the second side 22 of the casing. In some implementations, the charging device may include at least one set of magnets within the cavity of the casing. The magnets may be positioned along a side of the casing adjacent to the charging pad. The magnets may be configured to engage a personal electronic device to couple the personal electronic device with the charging pad. In various implementations, one or more metal plates may aid in coupling the electronic device with the charging pad and the inductive coils. In other implementations, the charging device may include a first set of magnets and a second set of magnets. The first set of magnets and the second set of magnet may be positioned on opposing sides of the casing near the edges of the casing. A first set of magnets and a second set of magnets may provide a stronger hold on a personal electronic device. In various implementations, the personal electronic devices may have metal cases that may be engaged by the magnets. In some implementations, the personal electronic devices may have metal adaptor or attachments that may engage with the magnet. A non-limiting example of personal electronic devices having a metal case includes iPhones manufactured by Apple, Inc. of Cupertino, Calif.

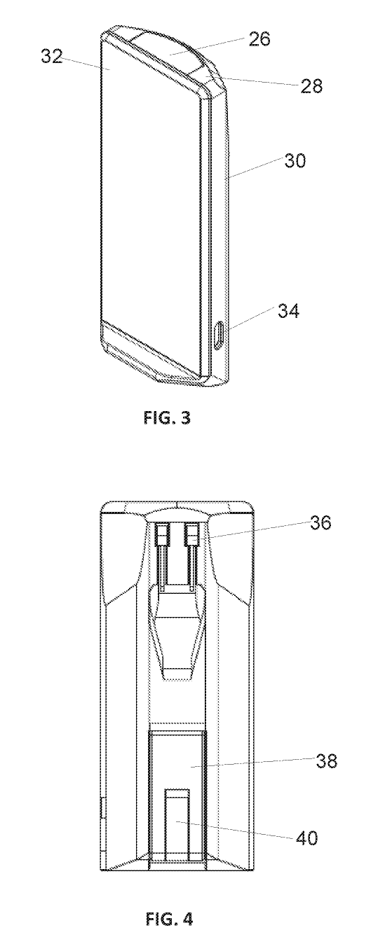

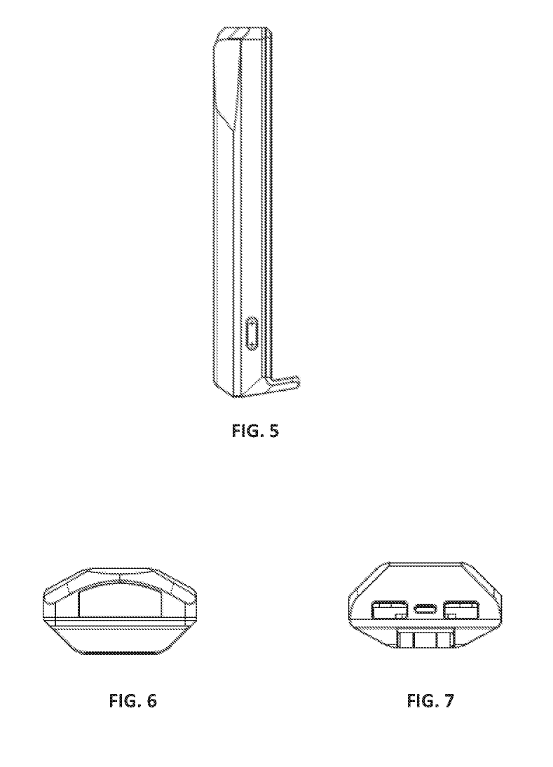

Referring to FIG. 3, a top perspective view of an implementation of a charging device is illustrated. The charging device includes a display 26 on a second end 28 of the casing 30. In various implementations, the display may span the entire second end of the casing. In other implementations, the display may only cover a portion of the second end of the casing. In FIG. 6, a top view of the display on the second end of the casing is illustrated. In still other implementations, the display 26 may be a wrap around display in that it covers a portion of the first side 32 of the casing 30 and the second end 28 of the casing 30. The display may be a liquid crystal display (LCD), organic light emitting diode (OLED), or other suitable screen including a matrix of pixels usable to display status information. The display may provide information about the charging device such as, by non-limiting example, the amount of life remaining in the battery pack, electrical current output or present voltage potential of the battery, charging capacity, time until a phone or other device is fully charged, time until the internal battery of the charging device is fully charged, how much storage is available on the electronic device or wired flash hard drive, and other information that may be helpful to a user. In other embodiments, the display can include a series of discrete light emitting diodes (LEDs), wherein the number of LEDs turned on indicates a percentage of remaining battery power or other piece of information. In still other implementations, the display or charging device may include colored lights including LEDs that indicate the status of the charging device. A button 34 positioned on an edge of the casing may toggle the various modes of the display. In various implementations, the button may be positioned towards a first end of the casing, a second end of the casing, or in the middle of the casing. In some implementations, the display may be touch enabled allowing a user to toggle between modes through tapping of a finger on the display. The charging device may include a second controller that is coupled to the display and a memory. The second controller may be configured to provide the operating parameters for the displays and various mode therein.

Referring to FIG. 4, a second side of the casing is illustrated. An electrical power plug 36 rotatably coupled to the second end of the second side of the casing is illustrated. The electrical power plug 36 is in a closed position. When in a closed position, the electrical power plug is substantially flush with the casing providing a streamline design. The streamline design may help with packaging and storage of the charging device. In various implementations, the electrical power plug may be hingedly coupled to the casing of the charging device. The electrical power plug is configured to be inserted into an electrical outlet. In some implementations, the electrical power plug may be adapted for a 120V outlet. In other implementations, the electrical power plug may be adapted for a 220V outlet. In various implementations, the electrical power plug may be used with an adapter to allow use of the charging device in a variety of countries having different orientations of power outlets. In some implementations, a power adapter may be included within the casing of the charging device. The electrical power plug is configured to charge the battery pack and the battery pack is configured to energize the one or more inductive coils. The electrical power plug is also configured to charge one or more electronic devices coupled with the charging device through the one or more inductive coils or ports. The battery pack in this and all implementations described herein may be charged through a rapid charge process. In various implementations, the battery pack may hold a charge that allows full usage of the charging device for several days without recharging the internal battery pack.

Still referring to FIG. 4, the charging device includes a stand 38 hingedly coupled to a second side of the casing adjacent to the electrical power plug 36. The stand 38 is configured to support the charging device in a substantially upright position when the stand is in an open position. The stand includes a pull out 40 hingedly coupled to an inner portion of the stand. The pull out 40 portion may be configured to maintain an angle of the device when the electrical power plug of the device is inserted into an electric outlet. In some implementations, a magnetic mount may be included on a second side of the casing between the electrical power plug and the stand. The magnetic mount may be configured to couple with a metal surface having a circular shape. In various implementations, the metal surface may have a planar or flat shape. The magnetic mount may be configured to slidably couples with the metal surface. The magnetic mount may allow the charging device to swivel on the metal surface allowing a user to position the charging device in a near 360 degree rotation. In other implementations, the magnetic mount may allow the charging device to rotate in a 180 degree rotation.

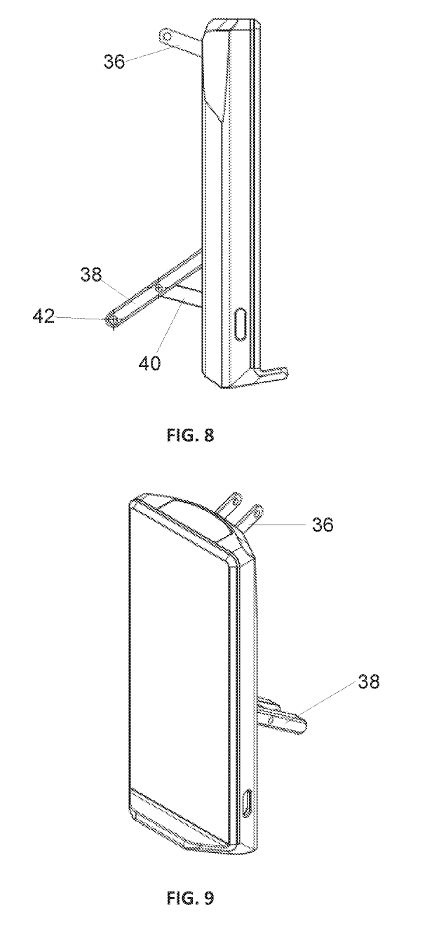

Referring to FIGS. 8 and 9, the charging device is illustrated having the electrical plug 36 and stand 38 each in an open position. The legs of the stand include embedded magnets 42. The embedded magnets may help the stand to stay in an open position. The pull out 40 is illustrated extending from the stand and resting against the second side of the casing.

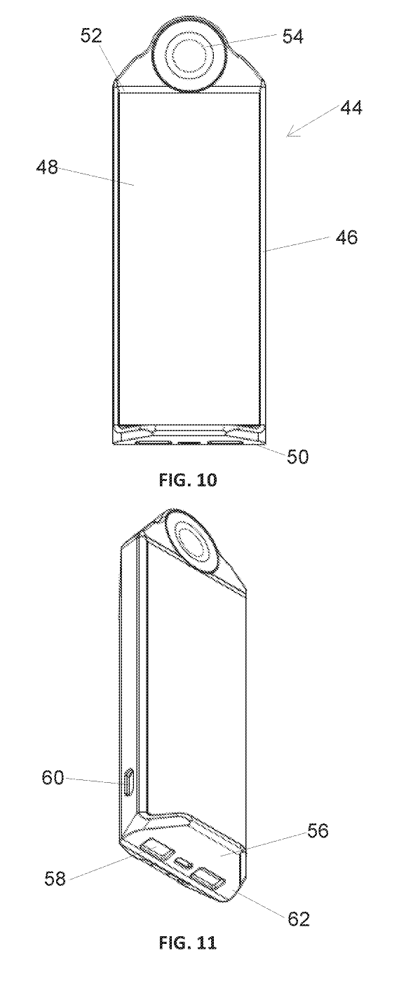

Referring to FIG. 10, another implementation of a charging device 44 is illustrated. The charging device includes a casing 46 and a first charging pad 48 on a first side of the casing. The first charging pad may extend from a first end 50 of the casing to a second end 52 of the casing. In some implementations, the first charging pad may be smaller than illustrated. The charging device includes one or more inductive coils adjacent to the first side of the casing and adjacent to the charging pad. The one or more inductive coils are positioned on a side of the first casing opposite the charging pad. The charging device also includes a battery pack within the casing. As previously described, the casing may be formed through injection molding, 3D printing, and other manufacturing techniques for rigid materials. In some implementations, the battery may be embedded within the casing. In other implementations, the battery pack may be positioned within a cavity of the casing.

Still referring to FIG. 10, a second charging pad 54 is on a first side of the casing. The second charging pad 54 is positioned at a second end 52 of the casing. In some implementations, a display may be positioned between the first charging pad and the second charging pad. A top view of the second charging pad is illustrated in FIG. 15. The second. charging pad may be used to charge other electronic devices such as, by non-limiting example, an Apple Watch, a product of Apple, Inc. of Cupertino, Calif. In other implementations, a display 64 may be positioned on an edge of the casing as illustrated in FIG. 12. The display may include several modes as previously described. As used herein, a display may also be referred to as a screen. The various modes of the display may be toggled through by using a button 66 on an edge of the casing. The charging device may include one or more controllers. The controllers may be used to direct the functions of the modes of the display. The controllers may also be used to direct the charging hierarchy as previously described.

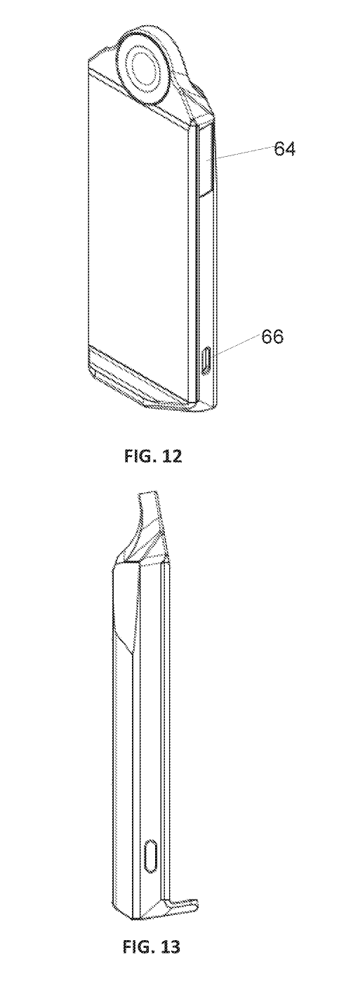

Referring to FIG. 11, the charging device is illustrated from a bottom perspective view. The charging device includes a shelf 56 on a first end of the casing. The shelf is configured to support an electronic device. In various implementations, the shelf may be in a fixed location and position. In other implementations, the shelf may be rotatably coupled to the casing of the charging device. The rotatably coupled shelf may be folded into a closed position for compact packaging and storage of the device. In FIG. 13, a side view of an implementation of a charging device illustrates the shelf in a fully extended position.

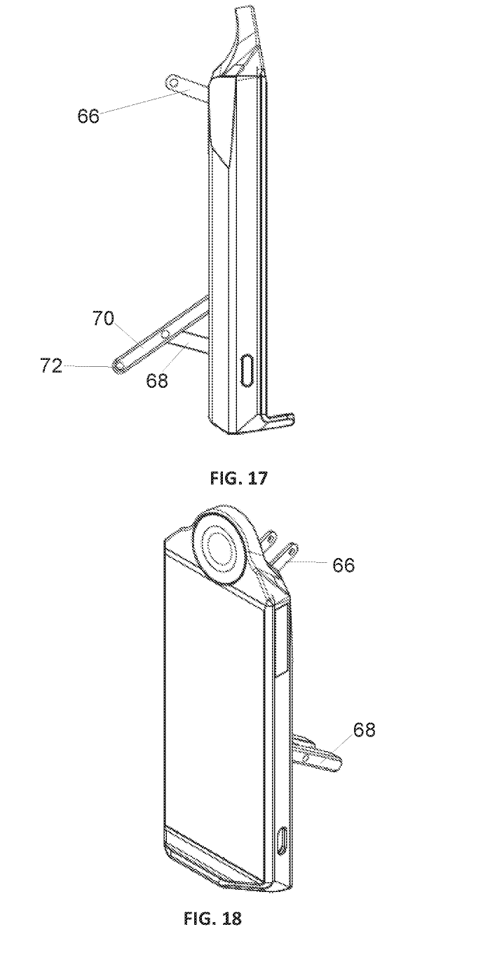

The charging device also includes one or more ports 58 and 60. The one or more ports may be on the first end 62 of the casing in various implementations. In other implementations, the ports may be positioned on an edge of the casing. The ports may be coupled with a processor and a memory within the casing. In various implementations, the ports may be used as an alternative method for charging the battery pack. In some implementations, the ports may be used to charge additional electronic devices. The ports may also be coupled with data storage within the charging device. In various implementations, the charging device may have Bluetooth capabilities built into the device. In some implementations, the ports may be coupled with the controller coupled to the display and the ports may allow a user to program, update, or change the modes of the display. In FIG. 16, a top view of an implementation of ports positioned on a first end of the casing is illustrated.

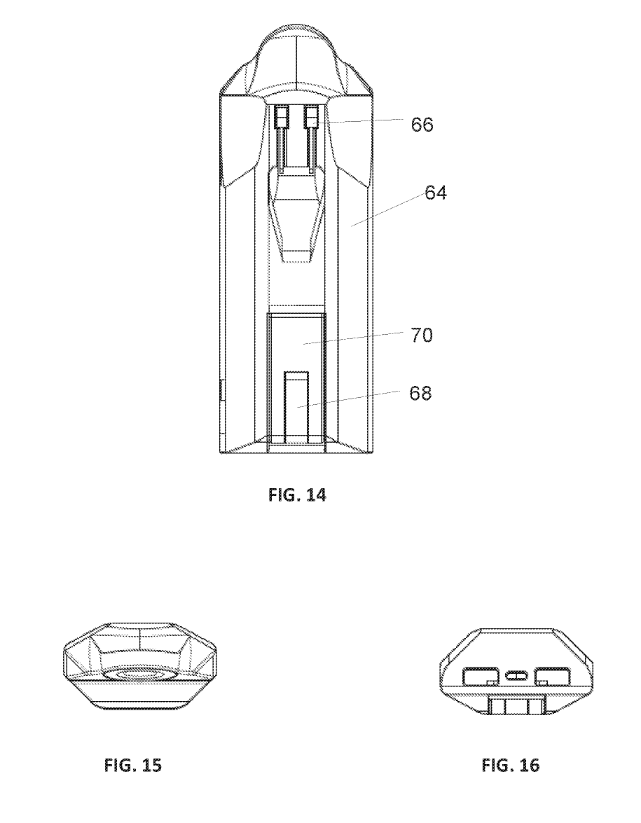

Referring to FIG. 14, a second side 64 of the casing is illustrated. An electrical power plug 66 is rotatably coupled to a second side 64 of the casing. The electrical power plug 66 is configured to be inserted into an electrical outlet when in an open position as illustrated in FIGS. 17 and 18. The electrical power plug is configured to charge the battery pack and the battery pack is configured to energize the one or more inductive coils. In various implementations, the voltage received through the electrical power plug may energize the one or more inductive coils directly. The one or more inductive coils are configured to wirelessly transmit energy to an electronic device disposed on or adjacent to the charging pad. A controller within the casing is configured to control the resonant coupling between the one or more inductive coils and an inductive coil in a device being charged. In various implementations, an adapter may be coupled to the electrical power plug both as an extender and when used in different countries. When an adapter is used the pull out 68 coupled to an inner portion of the stand 70 is used to maintain an angle of the charging device to keep an electronic device disposed on the charging device for charging. As previously described, the legs of the stand include one or more magnets 72 to further support the charging device in a substantially upright position.

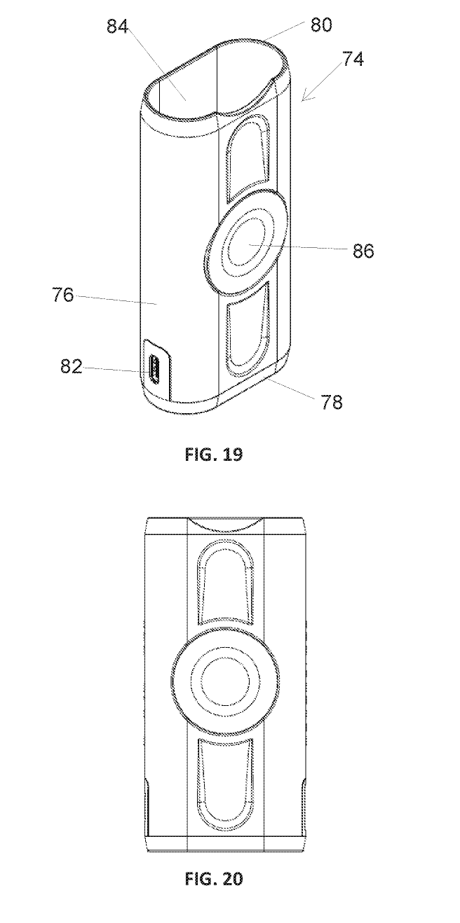

Referring to FIGS. 19-22, an additional implementation of a charging device 74 is illustrated. The device includes a casing 76 having a first end 78 and a second end 80. The first end of the casing includes a cavity containing the electrical components of the device such as, by non-limiting example, a battery pack, one or more inductive coils, a controller, or any combination thereof. In other implementations, the electrical components may also include a processor and memory. The processor and memory may be coupled with the port 82 illustrated on a side of the casing. The second end of the casing includes a docking location 84 for an electronic device. In various implementations, the docking location is sized to receive an AirPod case. AirPods are a product of Apple, Inc. of Cupertino, Calif. The docking location may include a charging port configured to receive a lighting male plug included on the AirPods case. The AirPods may be charged directly through the charging port when the charging device is plugged into a wall. The device also includes a charging pad 86 on a first face of an outer surface of the casing. The charging pad is configured to facilitate the charging of electronic devices such as, by non-limiting example, an Apple Watch as described for other implementations disclosed in this document. In FIG. 20 a front view of a first face of an additional implementation of a charging device is illustrated.

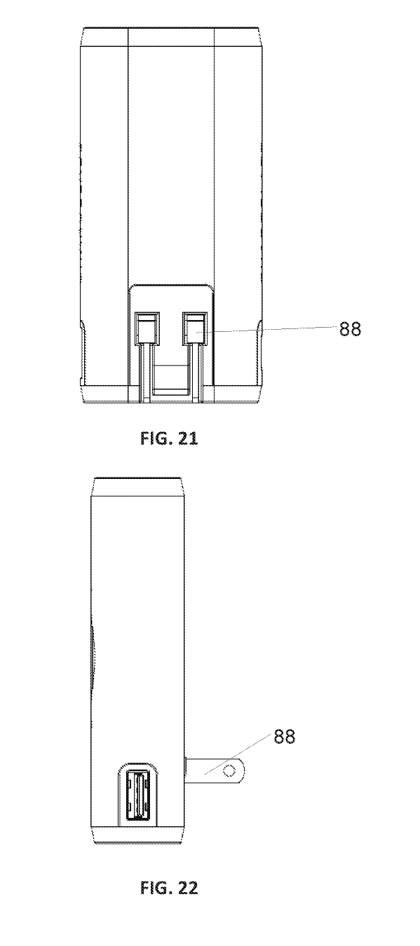

Referring to FIGS. 21 and 22, an electrical power plug 88 rotatably coupled to a second face of the casing is illustrated. In FIG. 21, the electrical power plug 88 is illustrated in a closed position. In FIG. 22, the electrical power plug 88 is illustrated in an open position. The electrical power plug is configured to be inserted into an electrical outlet. The electrical power plug is configured to charge the battery pack. The battery pack is configured to energize the one or more inductive coils. In various implementations, the one or more inductive coils may be energized directly through the charging device when the charging device is inserted into an electrical outlet using the electrical power plug. The controller is configured to control the resonant coupling between the one or more inductive coils and an inductive coil in a device being charged.

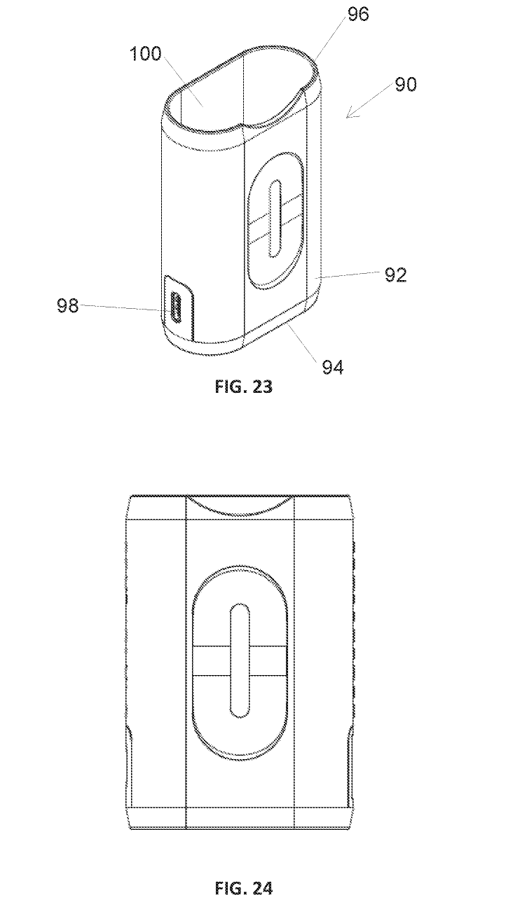

Referring to FIGS. 23-26, an alternative implementation of a charging device 90 is illustrated. The device includes a casing 92 having a first end 94 and a second end 96. One or more electrical components of the device such as a battery pack, one or more inductive coils, and a controller are included within the first end 94 of the casing. In other implementations, the electrical components may also include a processor and memory. The processor and memory may be coupled with the port 98 illustrated on a side of the casing. The second end of the casing includes a docking location 100 for an electronic device. In various implementations, the docking location is sized to receive an AirPods case as previously described. The docking location may include a charging port configured to receive a lighting male plug included on the AirPods case. The AirPods may be charged directly through the charging port when the charging device is plugged into a wall.

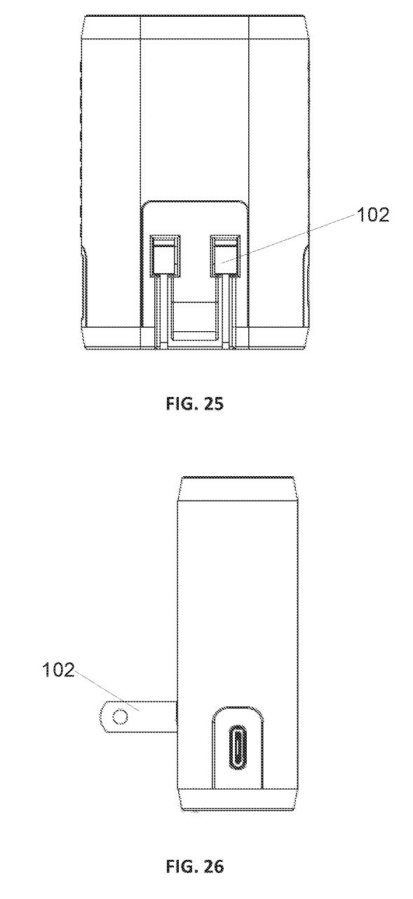

Referring to FIGS. 25 and 26, an electrical power plug 102 rotatably coupled to a second side of the casing is illustrated. In FIG. 25, the electrical power plug 102 is illustrated in a closed position. In FIG. 26, the electrical power plug 102 is illustrated in an open position. The electrical power plug is configured to be inserted into an electrical outlet. The electrical power plug is configured to charge the battery pack. The battery pack may be used to charge a device coupled with the charging device. In various implementations, a device coupled with the charging device may be charged directly through a wall outlet when the electrical power plug is inserted into an electrical outlet.

Various implementations of charging devices as described herein may be portable, self-powered, have wireless charging capabilities, and/or have a battery pack. Implementations of the charging devices may include a wall mount, a stand, or a combination thereof. Various implementations may include hardwired or wireless hard drives, Bluetooth connection capability, and any combination thereof.

In places where the description above refers to particular implementations of charging device and implementing components, sub-components, methods and sub-methods, it should be readily apparent that a number of modifications may be made without departing from the spirit thereof and that these implementations, implementing components, sub-components, methods and sub-methods may be applied to other charging devices.

What is claimed is:

1. A charging device comprising:
a casing having a first side and a second side;
a charging pad on a first side of the casing;
one or more inductive coils comprised adjacent to the first side of the casing and adjacent to the charging pad;
a battery pack comprised within the casing; and
an electrical power plug rotatably coupled to a second side of the casing, the electrical power plug configured to be inserted into an electrical outlet;
a controller that is configured to control the resonant coupling between the one or more inductive coils and an inductive coil in a device being charged;
wherein the electrical power plug is configured to charge the battery pack and the battery pack is configured to energize the one or more inductive coils; and
wherein the one or more inductive coils are configured to wirelessly transmit energy to an electronic device disposed on or adjacent to the charging pad.

2. The device of claim 1, further comprising a second controller that is coupled to the display and a memory.

3. The device of claim 1, wherein the electrical power plug is hingedly coupled to the second side of the casing.

4. The device of claim 1, further comprising;
a stand rotatably coupled to a second side of the casing adjacent to the electrical power plug; and
a pull out rotatably coupled to an inner portion of the stand, the pull out portion configured to maintain an angle of the device when the electrical power plug of the device is inserted into an electric outlet.

5. The device of claim 1, further comprising a first set of magnets and a second set of magnets positioned on opposite sides of the one or more inductive coils, the first set of magnets and the second set of magnets configured to engage a personal electronic device to couple the personal electronic device with the charging pad.

6. The device of claim 1, further comprising a shelf comprised on a first end of the casing, the shelf configured to support an electronic device.

7. The device of claim 1, further comprising a display comprised on a second end of the casing.

8. The device of claim 1, further comprising a magnetic mount on a second side of the casing, the magnetic mount configured to couple with a metal surface having one of a circular shape or a planar shape.

9. The device of claim 1, further comprising at least one of a universal serial bus (USB) type A port, a USB type C port, a non-volatile data storage, wireless storage data, and any combination thereof.

10. The device of claim 1, wherein the controller of the device is configured to follow a hierarchy of charging when plugged into a wall wherein one or more electronic devices coupled with the device are charged before the battery pack.

11. A charging device comprising:
a casing comprising a battery pack and one or more inductive coils embedded within a cavity of the casing;
a charging pad on a first outer surface of the casing;
an electrical power plug rotatably coupled to a second side of the casing, the electrical power plug configured to be inserted into an electrical outlet;
a display comprised on a first outer surface of the casing adjacent the charging pad;
a button on an edge of the casing, the button configured to toggle between one or more modes on the screen; and
a shelf comprised on a first end of the casing, the shelf configured to support an electronic device;
wherein the electrical power plug is configured to charge the battery pack and the battery pack is configured to charge the one or more inductive coils; and
wherein the one or more inductive coils are configured to wirelessly transmit energy to an electronic device disposed on or adjacent to the charging pad.

12. The device of claim 11, further comprising a controller that is configured to control the resonant coupling between the one or more inductive coils and an inductive coil in a device being charged.

13. The device of claim 11, further comprising:
a stand rotatably coupled to a second side of the casing adjacent to the electrical power plug; and
the stand further comprising a pull out configured to maintain an angle of the device when the electrical power plug of the device is inserted into an electrical outlet.

14. The device of claim 11, further comprising a magnetic mount on a second side of the casing, the magnetic mount configured to couple with a metal surface having a circular shape.

15. The device of claim 11, further comprising at least one of a universal serial bus (USB) type A port, a USB type C port, a non-volatile data storage, wireless storage data, and any combination thereof.

16. The device of claim 11, further comprising at least one set of magnets, the set of magnets configured to engage a personal electronic device to couple the personal electronic device with the charging pad.

17. A charging device comprising:
a casing having a first side and a second side;
a charging pad on a first side of the casing;
one or more inductive coils comprised adjacent to the first side of the casing and adjacent to the charging pad;
a battery pack comprised within the casing; and
an electrical power plug rotatably coupled to a second side of the casing, the electrical power plug configured to be inserted into an electrical outlet;
a controller that is configured to control the resonant coupling between the one or more inductive coils and an inductive coil in a device being charged; and
a second charging pad comprised on a first side of the casing;
wherein the electrical power plug is configured to charge the battery pack and the battery pack is configured to energize the one or more inductive coils; and
wherein the one or more inductive coils are configured to wirelessly transmit energy to an electronic device disposed on or adjacent to the charging pad.

18. The device of claim 17, further comprising:
a stand rotatably coupled to a second side of the casing adjacent to the electrical power plug; and
a pull out rotatably coupled to an inner portion of the stand, the pull out portion configured to maintain an angle of the device when the electrical power plug of the device is inserted into an electric outlet.

19. The device of claim 17, further comprising a shelf comprised on a first end of the casing, the shelf configured to support an electronic device.

20. The device of claim 17, wherein the controller of the device is configured to follow a hierarchy of charging when plugged into a wall wherein one or more electronic devices coupled with the device are charged before the battery pack.
